(19) United States
(12) Patent Application Publication
(10) Pub. No.: US 2010/0275142 A1
(43) Pub. Date: Oct. 28, 2010

(54) APPLICATION OPERATION CONTROL APPARATUS

(76) Inventor: Yoshimasa Okubo, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/763,075

(22) Filed: Apr. 19, 2010

(30) Foreign Application Priority Data
Apr. 27, 2009 (JP) 2009-107927

(51) Int. Cl. G06F 3/048

(52) U.S. Cl. 715/765

(57) ABSTRACT

According to one embodiment, an application operation control apparatus includes a manager, a creator, and a controller. The manager is configured to manage an application configured in XML and script. The creator is configured to create a dummy application with reference to the manager, the dummy application corresponding to a first application being temporarily inaccessible and being stored in an external storage medium. The controller is configured to control an operation based on the dummy application and a second accessible application managed by the manager.

### CROSS-REFERENCE TO RELATED APPLICATIONS

This application is based upon and claims the benefit of priority from Japanese Patent Application No. 2009-107927, filed Apr. 27, 2009, the entire contents of which are incorporated herein by reference.

### FIELD

Embodiments described herein relate generally to an application operation control apparatus which controls the operation of an application called a widget configured in XML, script, and others.

### BACKGROUND

In recent years, small-scale applications known as widgets configured in XML, script, and others capable of accessing the Internet have been attracting attention. Java (registered trademark) script, XML, HTML, or Adobe Flash (registered trademark) can be used to develop widgets. Moreover, widgets can be applied to digital television and the like. This makes it possible to use widgets on digital TV or the like, enabling the user to watch news, weather forecasts, stock information, or the like on TV. Jpn. Pat. Appln. KOKAI Publication No. 2002-297276 (document 1) has disclosed the technique relating to widget drawing control.

A widget platform (widget channel) for executing a widget has been known as the technique concerning widgets. The widget platform, which is created on the assumption that it is mounted on a CE unit, has the following features:

(1) The widget platform displays a widget graphical user interface (GUI) at one end of the screen or the like so as not to interfere with the information (e.g., TV screen) displayed by the CE unit.

(2) The widget platform controls a widget according to the minimum operation of keys (arrow key+OK key+some other special keys) on a remote controller or the like.

(3) The widget platform downloads a widget from a server on the Internet.

However, the widget platform has the following weaknesses because it has been created on the assumption that it is mounted on the CE unit as described above:

(1) It is not assumed that a widget is stored in an external storage.

(2) A list of widgets used by the user is created on the basis of a database stored in the apparatus.

(3) The database is created at the time of the first start-up or initial setting. The database also includes a widget display sequence. That is, the widget platform searches an accessible storage for a widget at the start-up of the apparatus. Then, the widget platform creates a list of widgets retrieved. Therefore, it is difficult for the widget platform to update the list without restarting the apparatus.

Even with the technique disclosed in document 1, it is conceivable that it is difficult to avoid the weaknesses. For example, with the technique disclosed in document 1, it is conceivable that it is difficult to draw the GUIs and others of widgets stored in the currently inaccessible storage.

### BRIEF DESCRIPTION OF THE DRAWINGS

FIG. 1 is an exemplary diagram showing a schematic configuration of a TV (broadcast receiving apparatus) on which a widget platform according to an embodiment has been mounted;

FIG. 2 is an exemplary diagram showing a schematic configuration of the widget platform according to the embodiment;

FIG. 3 shows an example of an external storage (USB-HDD) that can be connected to the TV of FIG. 1;

FIG. 4 shows an example of a database for managing information on widgets stored in each storage;

FIG. 5 is an exemplary view showing a display of the GUI of each widget including the GUI of a game widget belonging to an accessible external path;

FIG. 6 is an exemplary view showing a display of the GUI of each widget including the GUI of a game widget belonging to an inaccessible external path;

FIG. 7 is a flowchart showing an example of a start-up process;

FIG. 8 is a flowchart showing an example of a disconnection process;

FIG. 9 is a flowchart showing an example of a connection process;

FIG. 10 is an exemplary view showing a display of a GUI by a conventional widget platform and a display of a GUI by the widget platform of the embodiment;

FIG. 11 is an exemplary view showing a case where dummy widget information (the GUI of a dummy widget) is not displayed; and

FIG. 12 is an exemplary view showing a display of an error message when the GUI of a dummy widget has been selected.

### DETAILED DESCRIPTION

In general, according to one embodiment, an application operation control apparatus includes a manager, a creator, and a controller. The manager is configured to manage an application configured in XML and script. The creator is configured to create a dummy application with reference to the manager, the dummy application corresponding to a first application being temporarily inaccessible and being stored in an external storage medium. The controller is configured to control an operation based on the dummy application and a second accessible application managed by the manager.

Hereinafter, referring to the accompanying drawings, an embodiment will be explained.

An apparatus provided with a widget platform has a nonvolatile internal memory for storing widgets. However, such an apparatus is generally a CE unit. From a cost viewpoint, the CE device which is inexpensive is often provided with only a lower-capacity memory. In contrast, no quantitative restriction has been placed on widgets and therefore the probability that high-capacity widgets will be shipped is not low.

Therefore, the widget platform has to support a case where a widget will be stored in an external storage, such as a USB-HDD. However, a conventional widget platform does not sufficiently support a case where a widget will be stored in an external storage, such as a USB-HDD. Accordingly, the conventional widget platform has the following weaknesses:

(1) The widget platform can acquire information on the widgets stored in the storage only when the apparatus starts up or logins. Therefore, the widget platform cannot execute a widget whose existence cannot be checked when the apparatus starts up or logins. That is, the widget platform cannot execute a widget that cannot be accessed when the apparatus starts up or logins.

(2) The widget platform does not manage information on whether a widget has been stored in an external storage. That is, the widget platform does not manage information on whether a widget has been stored in an external storage or an internal storage.

In contrast to the conventional widget platform, a widget platform (or an application operation control apparatus) of the embodiment creates a dummy widget (a dummy application) corresponding to a widget (or application) that cannot be accessed at the time of start-up. For example, the widget platform creates a database (a manager) for each widget on the basis of the past access history and, on the basis of the database, creates dummy widgets corresponding to the widgets stored in an external storage that cannot be accessed at start-up. This enables the widget platform to manage inaccessible widgets as dummy widgets on the list.

In addition, on the basis of the detection of the connection of the external storage, the widget platform of the embodiment replaces a dummy widget with an actual widget using the detection of the connection as a trigger. That is, on the basis of the detection of the connection of the external storage, the widget platform searches the external storage for an actual widget corresponding to the dummy widget. When having found an actual widget corresponding to the dummy widget from the external storage, the widget platform replaces the dummy widget with the actual widget.

Moreover, the widget platform of the embodiment replaces the actual widget with a dummy widget on the basis of the detection of the disconnection of the external storage and the past access history.

Furthermore, the widget platform of the embodiment causes the design of the GUI of an external widget stored in a demountable external storage to differ from the design of the GUI of an internal widget stored in a permanently-set internal storage. For example, the outer frame or background color of the GUI of the external widget is made different from that of the GUI of the internal widget. In addition, the widget platform causes the design of the GUI of a connected external widget stored in an external storage now being connected to differ from that of the GUI of a disconnected external widget stored in an external storage now being disconnected.

Making the designs differ as described above enables the user to easily tell whether a widget corresponding to the GUI is an internal widget or an external widget just by looking the GUI. Moreover, just by looking at the GUI, the user can easily tell whether the widget corresponding to the GUI is a connected external widget or a disconnected one.

Hereinafter, the widget platform (commonly known as the widget channel) of the embodiment roughly explained above will be explained in detail. A TV on which the widget platform is mounted will also be explained.

FIG. 1 shows a schematic configuration of a TV (a broadcast receiving apparatus) on which a widget platform of the embodiment has been mounted. As shown in FIG. 1, a TV 1 comprises a widget platform 11, a USB 12, an HDD (internal storage) 13, a CPU 14, a display 15, a speaker 16, Ethernet (registered trademark) 17, and a broadcast receiver 18.

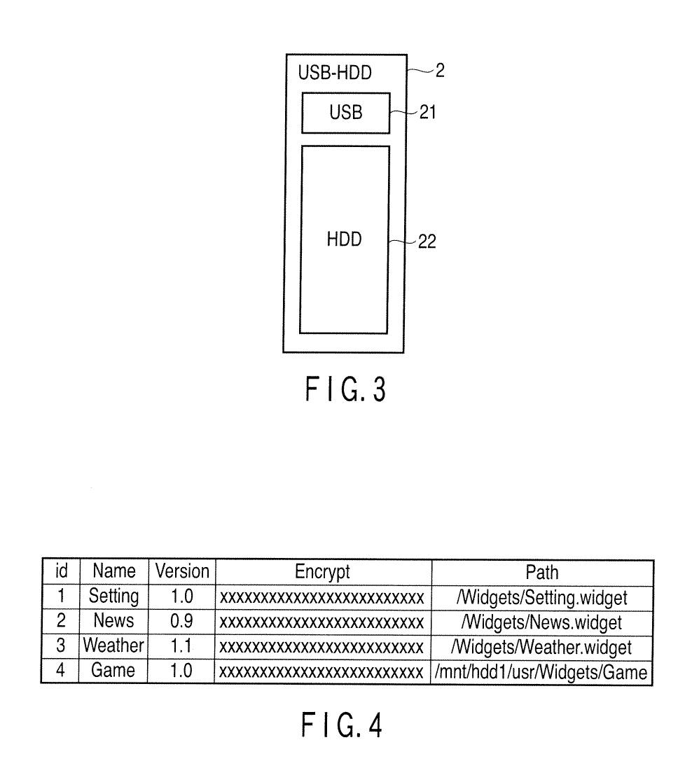

The outline of widget platform 11 has been explained above. The USB 12 is, for example, a bus for connecting with a USB-HDD (external storage) 2 as shown in FIG. 3. The HDD 13 is, for example, an internal HDD. For example, the HDD 13 stores a database shown in FIG. 4, the entities of three widgets (weather widget 1111, news widget 1112, setting widget 1113), and dummy widget 1114. In cooperation with the widget platform 11, the CPU 14 controls the operation of a widget, the reception of broadcasting by the broadcast receiver 18, or the video/audio output of received broadcasts. The display 15 displays the images of received broadcasts, the GUI of a widget, or information (e.g., news or weather forecast) that can be provided by a widget. The speaker 16 outputs the sound of received broadcasts. The Ethernet 17 downloads widgets or the like under the control of the widget platform 11 and others. The broadcast receiver 18 receives a broadcast signal and outputs broadcast contents (video and audio) corresponding to the broadcast signal to the display 15 and speaker 16 or to the HDD 13 to record broadcast contents.

Next, the following four mechanisms will be explained.

(1) Management database of widgets

(2) Structure of a widget

(3) Processing at the time of start-up or login

(4) Structure of a dummy widget

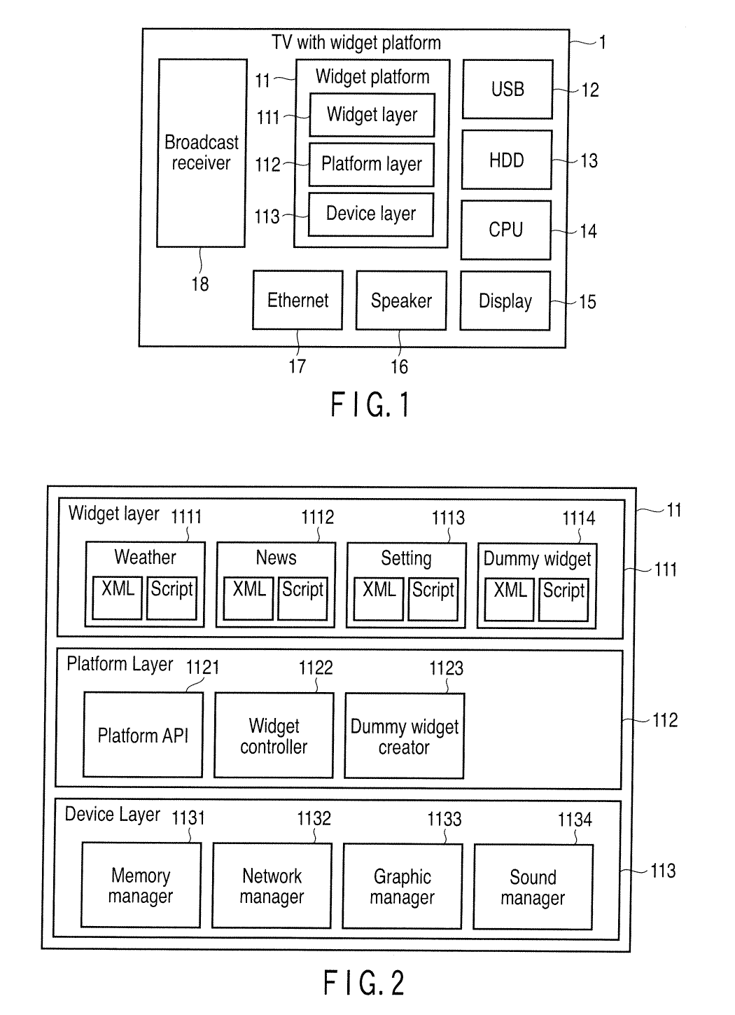

Firstly, a database of widgets will be explained. As shown in FIGS. 1 and 2, the widget platform 11 includes a widget layer 111, a platform Layer 112, and a device layer 113. The widget layer 111 manages the database stored in the HDD 13. The database manages information on each widget installed by the user. For example, the database manages information on a weather widget 1111, a news widget 1112, a setting widget 1113, and a game widget 1114 (see FIG. 4). The weather widget 1111, news widget 1112, setting widget 1113, and game widget 1114 are configured in XML and script. As shown in FIG. 4, the database holds the following pieces of information:
ID of widget
Name of widget
Version of widget
Storage location of widget (path)
Identification information on widget (encrypt this time)

The ID of a widget also serves as information on the display position. The ID of a widget may be stored for a reason other than information on the display position. On the basis of the history of accesses to the internal storage and external storage in the past, the widget platform 11 records the storage locations (external paths) of the widgets stored in the internal storage and external storage into the database.

Secondly, the structure of a widget will be explained. A widget is built up using the following three elements. Here, setting information is checked only at the time of start-up and has nothing to do with control being performed.
Setting information (widget.xml & main.TV)
XML
Script

Setting information is information that describes the basic setting. XML describes the structural elements of a widget screen. Script describes an application part of a widget.

Thirdly, the processing at the time of start-up or login will be explained. The widget platform 11 executes a start-up process in the following sequence:

(1) Read a database

(2) Check that a widget has been installed on the path of the database

(3) Acquire setting information on each widget and obtain widget name, ID, and others

(4) Check whether the widget on the path is correct, on the basis of identification information

(5) Access the network and check whether there is a widget of the latest version

(6) Give identifiers (application IDs) to the individual widgets and control each widget on the basis of the identifiers during the execution

(7) Read the XML file of each widget and construct a screen structure

(8) Read the script file of each widget and start up the widget

(9) The preparation of the Platform has been completed and the user can operate the widget

Fourthly, the structure of a dummy widget will be explained. For example, XML constituting a dummy widget is information to structure a GUI (outer frame) of the dummy widget. Script constituting the dummy widget describes the process of replacing the dummy widget with an actual widget and the process of responding to a call from the dummy widget. Identification information on the dummy widget is identification information on the actual widget. An example of the dummy widget is shown below:

XML:

```
<window>
  <frame id=“snippet0” vOffset=“0” hOffset=“0”
height=“155” width=“471”>
    <div height=“155” width=“471”
backgroundColor=”gray”/>
  </frame>
</window>
  Script:
<?xml version=“1.0” encoding=“utf-8”?>
<widget>
<script><![CDATA[
widget.onHostEvent = function(a_event) {
      switch (a_event.subject) {
      case ‘request_dummy’ :
            a_event.result = true;
            break;
      case ‘request_replace’ :
            eval(a_event.data);
            break;
      }
}
]]></script>
</widget>
```

For example, the widget platform 11 can displays the GUI of a dummy widget (unsubstantial widget) on the display 15 on the basis of the dummy widget. For example, the GUI of the dummy widget is displayed in gray. The GUIs of the weather widget, news widget, and setting widget are displayed in colors excluding gray.

The generation of dummy widgets and the roles of dummy widgets will be explained in detail. As described above, the TV 1, which includes the HDD (internal storage) 13, is configured to be capable of connecting with the USB-HDD (external storage) 2. For example, the HDD 13 stores the database shown in FIG. 4 and the entities of the weather widget 1111, news widget 112, and setting widget 1113 shown in FIG. 2. The USB-HDD 2 shown in FIG. 3 stores the game widget 1114a, the entity of the dummy widget 1114.

The following three situations will be explained.

(1) Situation S1 when TV 1 starts in a state where USB-HDD 2 is not connected

(2) Situation S2 when USB-HDD 2 is connected after TV 1 has started and been operating

(3) Situation S3 when the USB-HDD 2 is disconnected after USB-HDD 2 is connected and while it is operating

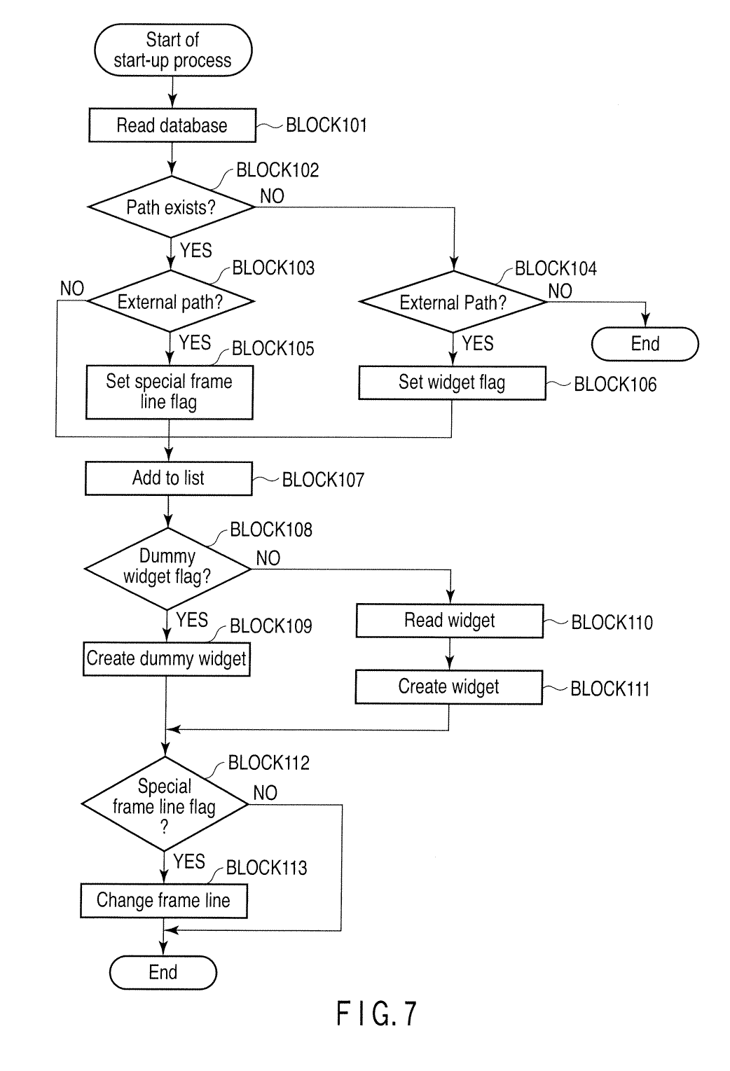

First, situation S1 will be explained with reference to a flowchart shown in FIG. 7. FIG. 7 is a flowchart to explain a start-up process.

After TV 1 starts and then widget platform 11, widget platform 11 reads the database of FIG. 4 from HDD 13 (BLOCK 101). On the basis of the read database, widget platform 11 checks the state of each path to which the corresponding one of the widgets belongs (BLOCK 102). That is, widget platform 11 checks whether each path to which the corresponding one of the widgets belongs is a currently accessible internal path, a currently accessible external path, or a currently inaccessible external path (BLOCK 102).

If there is a currently accessible internal path (YES in BLOCK 102) (NO in BLOCK 103), widget platform 11 acquires setting information on the widgets on a currently accessible internal path and adds the information to the list (BLOCK 107). For example, widget platform 11 acquires setting information on weather widget 1111, news widget 1112, and setting widget 1113 from the database and adds the information to the list.

If there is a currently accessible external path (YES in BLOCK 102) (NO in BLOCK 103), widget platform 11 sets a special frame line flag for displaying the GUI of the widgets belonging to the accessible external path (BLOCK 105) and acquires setting information on the widgets on the accessible external path from the database and adds the information to the list (BLOCK 107). For example, on the list, the special frame line flag for displaying the GUI of the widgets belonging to the external path is caused to correspond to setting information on the widgets on the accessible external path.

If there is an inaccessible external path (NO in BLOCK 102) (YES in BLOCK 104), widget platform 11 sets in the list a dummy widget flag for creating a dummy widget corresponding to a widget (game widget 1114a) on the inaccessible external path (BLOCK 106) and further acquires setting information on a widget on the inaccessible external path from the database and adds the information to the list (BLOCK 107). For example, on the list, the dummy widget flag for creating a dummy widget corresponding to game widget 1114a is caused to correspond to setting information on game widget 1114a.

After adding the setting information to the list, widget platform 11 checks whether the dummy widget flag is present on the list (BLOCK 108). On the basis of setting information not caused to correspond to the dummy widget flag (YES in BLOCK 108), widget platform 11 reads XML and script, the entities of widgets (BLOCK 110) and creates a widget on the basis of the read XML and script (BLOCK 111). That is, widget platform 11 creates weather widget 1111, news widget 1112, and setting widget 1113. Widget layer 111 manages these weather widget 1111, news widget 1112, and setting widget 1113.

On the basis of the setting information to which the dummy widget flag has been caused to correspond (YES in BLOCK 108), widget platform 11 instructs a dummy widget creator 1123 to create a dummy widget. As shown in FIG. 2, widget platform 11 includes a platform layer 112. The platform layer 112 includes a platform API 1121, a widget controller 1122, a dummy widget creator 1123.

Receiving the instruction to create the dummy widget, dummy widget creator 1123 creates a dummy widget on the basis of the setting information to which the dummy widget flag has been caused to correspond (BLOCK 109). That is, dummy widget creator 1123 creates a dummy widget 1114 corresponding to game widget 1114a. In other words, dummy widget creator 1123 creates the dummy widget when the external path is to be inaccessible or has become inaccessible. Widget layer 111 manages the dummy widget 1114 as well. That is, as shown in FIG. 2, Widget layer 111 manages weather widget 1111, news widget 1112, setting widget 1113, and dummy widget 1114.

On the basis of weather widget 1111, news widget 1112, setting widget 1113, and dummy widget 1114 managed by widget layer 111, a graphic manager 1133 creates GUIs for those widgets and outputs the created GUIs to the display 15. As shown in FIG. 2, widget platform 11 includes a device layer 113. The device layer 113 includes a memory manager 1131, a network manager 1132, a graphic manager 1133, and a sound manager 1134.

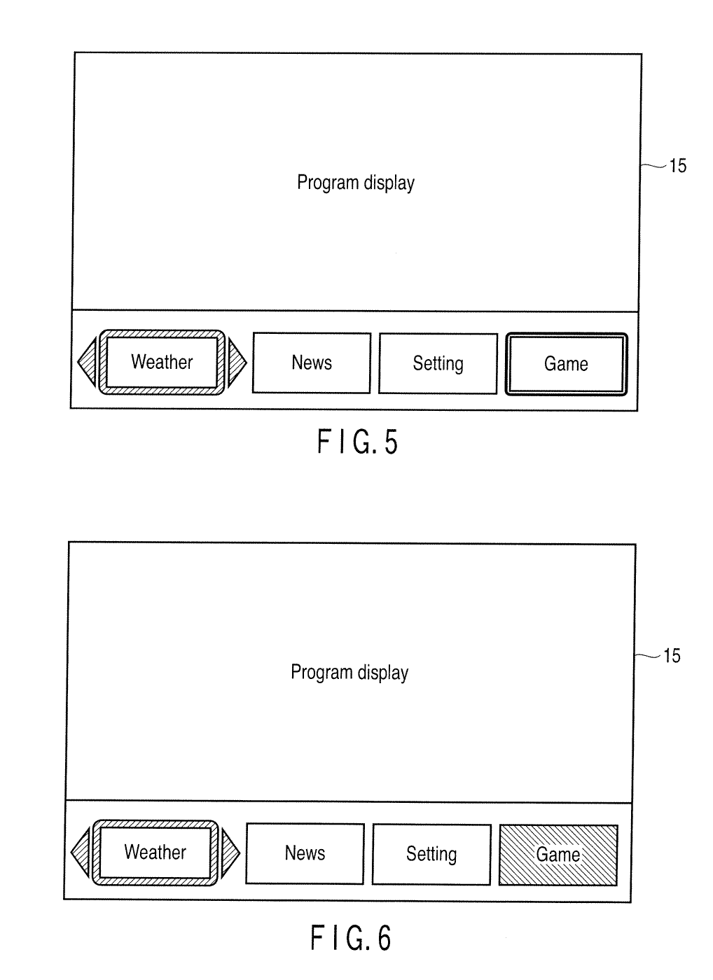

For example, graphic manager 1133 creates a GUI for weather widget 1111 using a frame line (e.g., black line) and a background color (e.g., red) specified in XML constituting weather widget 1111. Similarly, graphic manager 1133 creates a GUI for news widget 1112 using a frame line (e.g., black line) and a background color (e.g., blue) specified in XML constituting news widget 1112. Also similarly, graphic manager 1133 creates a GUI for setting widget 1113 using a frame line (e.g., black line) and a background color (e.g., green) specified in XML constituting setting widget 1113. In addition, graphic manager 1133 creates a GUI for dummy widget 1114 using a frame line (gray line) and a background color (gray) specified in XML constituting dummy widget 1114 (see FIG. 6).

Furthermore, on the basis of setting information to which the specific frame line flag has been caused to correspond (YES in BLOCK 112), widget platform 11 instructs graphic manager 1133 to create a GUI for the special frame line. Receiving the instruction to create a GUI for the special frame line, graphic manager 1133 generates a GUI for the special frame line on the basis of the setting information to which the special frame line flag has been caused to correspond (BLOCK 113). That is, graphic manager 1133 creates a GUI for a widget belonging to the accessible external path using a special frame line (e.g., red) and a background color (e.g., yellow) specified in XML constituting the widget.

With the GUIs being created as described above, the GUI (e.g., the GUI represented by a black frame) of a widget belonging to the currently accessible internal path, the GUI (e.g., the GUI represented by a red frame) of a widget belonging to the currently accessible external path, and the GUI (e.g., the GUI represented by a gray frame) of a widget belonging to the currently inaccessible internal path differ in display format. In other words, the GUI of the widget belonging to the currently accessible internal path, the GUI of the widget belonging to the currently accessible external path, and the GUI of the widget belonging to the currently inaccessible internal path differ in graphic. Accordingly, just looking at the GUI displayed on the display 15, the user can determine whether the widget corresponding to the GUI belongs to the currently accessible internal path, the currently accessible external path, or the currently inaccessible internal path.

When the start-up process has been completed, the user can operate. For example, if the GUI of a widget belonging to the currently accessible internal path has been selected, widget controller 1122 controls the operation according to the description in script for the widget. For example, if the GUI of weather widget 111 has been selected, widget controller 1122 acquires information on the weather forecast via Ethernet 17 and graphic manager 1133 displays the weather forecast on a part of the display 15. In addition, if the GUI of a widget belonging to the currently accessible external path has been selected, widget controller 1122 controls the operation according to the description in script for the widget. Moreover, if the GUI of a widget belonging to the currently inaccessible external path has been selected, that is, if the GUI of a dummy widget has been selected, widget controller 1122 controls the operation according to the description in script for the dummy widget. For example, if the GUI of a dummy widget has been selected, widget controller 1122 executes an error process (or displays an error message or the like) according to the description in script for the dummy widget.

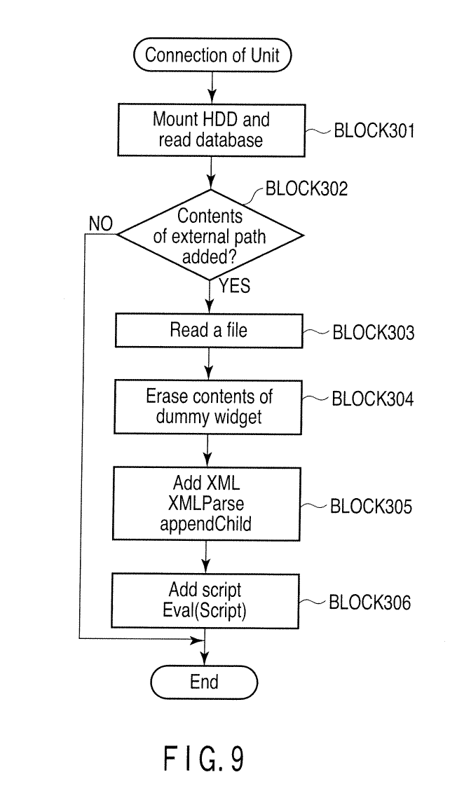

Next, situation S2 will be explained with reference to a flowchart shown in FIG. 9. FIG. 9 is a flowchart to explain a connection process.

In a state where the start-up process has been completed and the list has been created, if, for example, USB-HDD 2 is connected, USB 12 informs memory manager 1131 of the connection of USB-HDD 2 as an event. Memory manager 1131 mounts USB-HDD 2 in a suitable position, thereby setting USB-HDD 2 in a usable state (BLOCK 301) (YES in BLOCK 302). Then, widget platform 11 reads the database and acquires setting information on each widget from the read database. Alternatively, widget platform 11 acquires setting information on each widget from the database read in the start-up process.

When having checked that the connected USB-HDD 2 is a storage location for game widget 1114a corresponding to dummy widget 1114, widget platform 11 reads the file of game widget 1114a from the connected USB-HDD 2 (BLOCK 303), erases the contents of dummy widget 1114 (BLOCK 304), and adds the contents of the original game widget 1114a (BLOCK 305) (BLOCK 306). That is, the contents of dummy widget 1114 are replaced with the contents of game widget 1114a.

When the contents of game widget 1114a are added, XML carries out the process of adding analysis information to the present display contents, called appendChild, after the analysis of XML called parseXML. In addition, script carries out the process of executing all the contents input, called eval. Moreover, widget platform 11 sets a special frame line flag for displaying a GUI for game widget 1114a belonging to the accessible external path (USB-HDD 2). For example, on the list, the special frame line flag for displaying the GUI of game widget 1114a is caused to correspond to setting information on game widget 1114a. This enables graphic manager 1133 to create a GUI for game widget 1114a in a special frame line (e.g., red line) and in a background color specified in XML constituting game widget 1114a.

As a result, for example, the GUI of each widget is displayed as shown in FIG. 5. That is, the GUIs of weather widget 1111, news widget 1112, and setting widget 1113 belonging to the currently accessible internal path are created in a frame line (e.g., black line) and a background color specified in XML for each widget. The GUI of game widget 1114a belonging to the currently accessible external path is created in a special frame line (e.g., red line) and a background color specified in XML for game widget 1114a. FIG. 5 shows that weather widget 1111 is being selected. FIG. 5 shows a case where the contents (programs) received by the broadcast receiver 18 are displayed together with the GUI of each widget. The GUI of each widget may be displayed so as not to overlap with the contents (programs) or so as to overlap with (or be overlaid with) the contents as shown in FIG. 5.

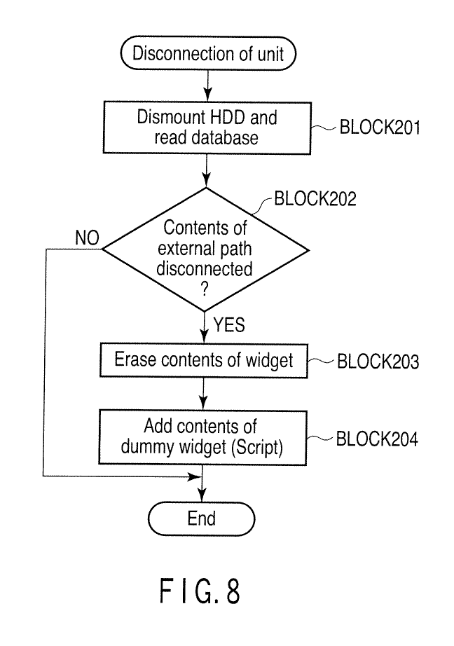

Next, situation S3 will be explained with reference to a flowchart shown in FIG. 8. FIG. 8 is a flowchart to explain a disconnection process.

When USB-HDD 2 has been dismounted, USB 12 informs memory manager 1131 of the disconnection of USB-HDD 2 as an event. Memory manager 1131 dismounts USB-HDD 2, thereby setting USB-HDD 2 in an unusable state (BLOCK 201) (YES in BLOCK 202). Then, widget platform 11 reads the database and acquires setting information on each widget from the read database. Alternatively, widget platform 11 acquires setting information on each widget from the database read in the start-up process.

Having checked that the disconnected USB-HDD 2 corresponds to the accessible external path, widget platform 11 erases the contents of game widget 1114a belonging to the accessible external path (BLOCK 203) and adds the contents of dummy widget 1114 corresponding to game widget 1114a (BLOCK 204). That is, the contents of actual game widget 1114a are replaced with the contents of dummy widget 1114.

The contents of game widget 1114a are erased by the process of erasing the displayed contents, called removeChild. Script is erased using the script-specific function of being capable of erasure by replacing a currently defined function with a similar function. After this is executed, the contents of dummy widget 1114 are added using appendChild and eval.

As a result, for example, the GUI of each widget is displayed as shown in FIG. 6. That is, the GUIs of weather widget 1111, news widget 1112, and setting widget 1113 belonging to the currently accessible internal path are created in a frame line (e.g., black line) and a background color specified in XML for each widget. The GUI of game widget 1114a belonging to the currently inaccessible external path (that is, the GUI of dummy widget 1114) is created in gray.

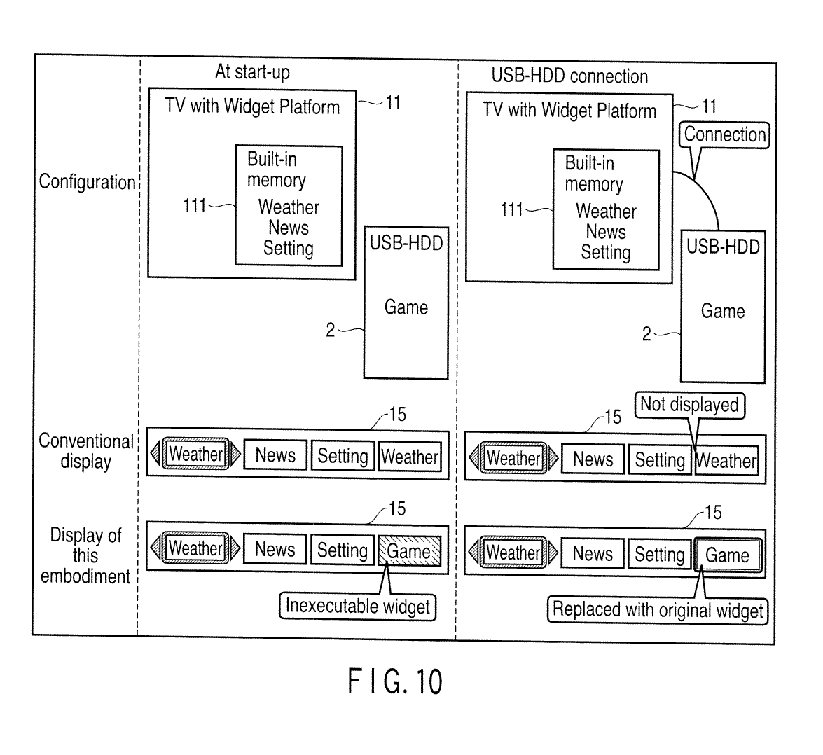

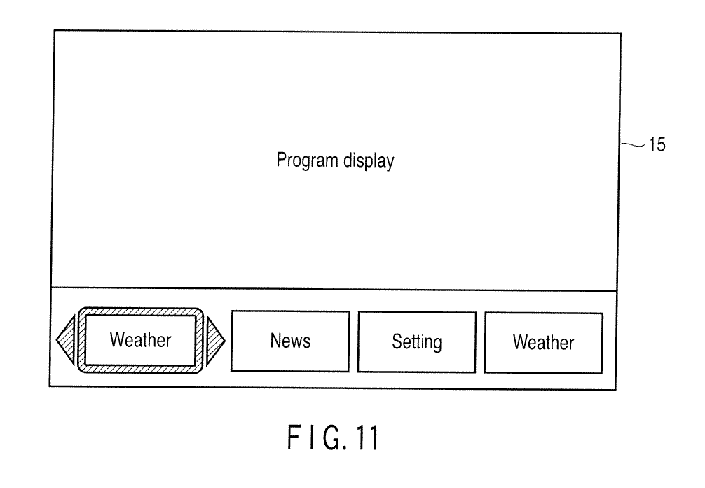

FIG. 10 shows a GUI display made by a conventional widget platform and a GUI display made by widget platform 11 of the embodiment.

For example, when USB-HDD 2 which has stored a game widget is not connected, information on the game widget is not included at all in the GUI display made by the conventional widget platform. The GUI display made by the conventional widget platform includes the GUI of the weather widget stored in the accessible built-in memory (e.g., built-in HDD), the GUI of news widget, and the GUI of setting widget. In contrast, the GUI display made by widget platform 11 of the embodiment includes the GUI of weather widget (GUI in a specified color in XML for weather widget), the GUI of news widget (GUI in a specified color in XML for news widget), the GUI of setting widget (GUI in a specified color in XML for setting widget), and the GUI of dummy widget corresponding to game widget (for example, GUI in gray).

In addition, when USB-HDD 2 which has stored a game widget is connected after start-up, information on the game widget is not reflected at all in the GUI display made by the conventional widget platform. In contrast, the GUI of the game widget (the GUI in a specified color in XML for the game widget) is reflected in the GUI display made by widget platform 11 of the embodiment. That is, the GUI of the dummy widget corresponding to the game widget is replaced with the GUI of the game widget.

While the case where the GUI of the dummy widget (e.g., a gray GUI) is displayed has been explained, the GUI of the dummy widget may not be displayed. For example, even if having detected the dummy widget flag on the list, widget platform 11 does not instruct dummy widget creator 1123 to create a dummy widget. This prevents the process of drawing the GUI of the dummy widget from being executed, preventing the GUI of the dummy widget from being displayed.

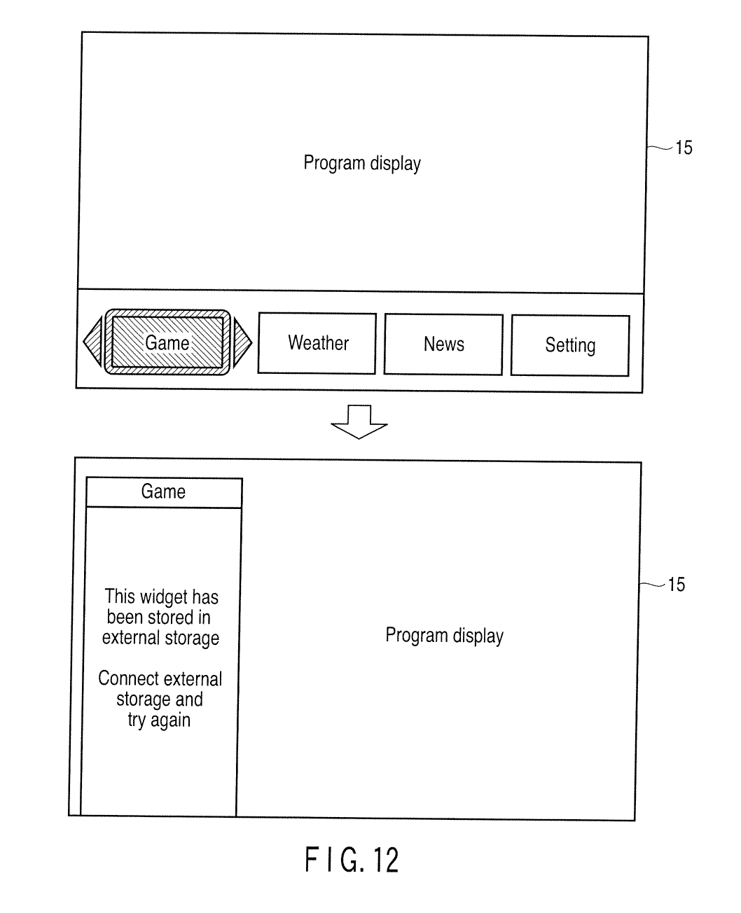

In a case where the GUI of a dummy widget is displayed, widget controller 1122 may display an error message according to the selection of the GUI of the dummy widget by the user as shown in FIG. 12. An error message can be displayed in XML and script for the dummy widget. This enables the user to know the reason why the widget cannot be executed and the execution of the widget requires the connection of an external storage.

Hereinafter, the embodiment is summarized as follows.

(1) Widget platform 11 checks for each widget on the basis of the database at the time of start-up. That is, widget platform 11 checks for widgets existing on the currently accessible internal path (HDD 13), widgets existing on the currently accessible external path (USB-HDD 2 being connected), and widgets existing on the currently inaccessible external path (USB-HDD 2 being disconnected). If it has been determined on the basis of the database that there is a widget on the currently inaccessible external path (USB-HDD 2 being disconnected), dummy widget creator 1123 creates a dummy widget corresponding to the widget on the currently inaccessible external path. Widget layer 111 collectively manages the widgets existing on the currently accessible internal path, widgets existing on the currently accessible external path, and the dummy widgets corresponding to the widgets existing on the currently inaccessible external path. Graphic manager 1133 creates the GUIs of all the widgets (including dummy widgets) managed by widget layer 111. In addition, platform layer 112 controls the operation based on all the widgets managed by widget layer 111. For example, according to the selecting operation of the GUI of a dummy widget, platform layer 112 (widget controller 1122) executes an error process on the basis of the description in script for the dummy widget (or outputs an error message).

(2) If the currently inaccessible external path has turned accessible, that is, if USB-HDD 2 has been connected, widget platform 11 (widget layer 111) replaces the dummy widget with an actual widget (widget stored in USB-HDD 2). Accordingly, using the connection of USB-HDD 2 as a trigger, widget platform 11 (widget layer 111) reads a widget from USB-HDD 2 and replaces the dummy widget with the read widget. As a result, graphic manager 1133 replaces the GUI of the dummy widget now being displayed with the GUI of the read widget.

(3) If the currently accessible external path has turned inaccessible, that is, if USB-HDD 2 has been disconnected, widget platform 11 (widget layer 111) replaces the actual widget (widget stored in USB-HDD 2) with a dummy widget. Accordingly, using the disconnection of USB-HDD 2 as a trigger, widget platform 11 (widget layer 111) replaces the read widget with a dummy widget. As a result, graphic manager 1133 replaces the GUI of the widget now being displayed with the GUI of the dummy widget.

(4) Graphic manager 1133 creates the GUI for a widget on the currently accessible internal path on the basis of the description in XML for the widget. That is, graphic manager 1133 creates a graphic specified in the description in XML using a frame line specified in the description in XML for the widget. In addition, graphic manager 1133 creates the GUI of a widget on the currently accessible external path on the basis of a special frame line flag and the description in XML for the widget. That is, graphic manager 1133 creates a graphic specified in the description in XML for the widget using a frame line corresponding to the special frame line flag. Moreover, graphic manager 1133 creates the GUI for a dummy widget corresponding to a widget on the currently inaccessible external path on the basis of the description in XML for the dummy widget. That is, graphic manager 1133 creates a graphic specified in the description in XML for the dummy widget using a frame line specified in XML for the dummy widget. Consequently, the GUI for a widget belonging to the currently accessible internal path, the GUI for a widget belonging to the currently accessible external path, and the GUI for a widget (or dummy widget) belonging to the currently inaccessible internal path differ in display format. Accordingly, the user can grasp the situations of widgets easily from the GUI display format.

(5) A dummy widget can have at least one of the following functions:

A. The GUI for a dummy widget is displayed in an outer frame only.

B. The contents (e.g., name and version) of a widget written in the database are displayed in the GUI of the dummy widget.

C. A logo representing a dummy widget is displayed in the GUI of the dummy widget. Alternatively, a logo representing a dummy widget is displayed as a GUI for the dummy widget.

D. The background color of the GUI of a dummy widget is set to a color different from the background color specified in XML for an actual widget corresponding to the dummy widget.

E. When the GUI of a dummy widget has been selected, an error message is displayed (see FIG. 12). For example, “Connect an external storage and try again” is displayed.

While the case where the GUI of a dummy widget is displayed has been explained, the dummy widget may have the function of not displaying information on the dummy widget (such as the GUI of the dummy widget) (see FIG. 11).

With this configuration, even when a widget has been stored in an external storage not connected at the time of start-up, information on the widget stored in the external storage can be provided without greatly changing the present processing procedure. For example, the GUI display of the dummy widget enables the user to realize that there is a widget which cannot be used at present. In addition, connecting an external storage enables the user to recognize that a widget which cannot be used at present can be used.

While the case where the GUI of a widget and the GUI of a dummy widget are displayed has been explained, the embodiment is not limited to the display of the GUIs, provided that information on a widget and a dummy widget is displayed. For instance, snippets of a widget and a dummy widget may be displayed.

While in the embodiment, the function widget platform has been provided in an apparatus. A similar function (e.g., an application operation control program) may be downloaded from a network into the apparatus. Alternatively, a recording medium in which the similar function has been recorded may be installed in the apparatus. The recording medium may be of any type, such as a CD-ROM or a DVD, provided that it can store a program and the apparatus can read it. The function installed or downloaded beforehand may be realized in cooperation with the operating system (OS) or the like of the apparatus.

The various modules of the device described herein can be implemented as software application, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel method and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An application operation control apparatus comprising:
a manager configured to manage an application configured in XML and script;
a creator configured to create a dummy application with reference to the manager, the dummy application corresponding to a first application being temporarily inaccessible and being stored in an external storage medium; and
a controller configured to control an operation based on the dummy application and a second accessible application managed by the manager.

2. The apparatus of claim 1, wherein the creator is configured to create the dummy application when the external storage medium is to be inaccessible or has become inaccessible.

3. The apparatus of claim 1, further comprising:
a graphic processor configured to output a first graphic for displaying the dummy application and output a second graphic for displaying the second accessible application.

4. The apparatus of claim 1, further comprising:
a graphic processor configured to output a first graphic for displaying the first application based on the dummy application corresponding to the first application being stored in the external storage medium being inaccessible and output a second graphic for displaying the second accessible application based on the second accessible application being stored in a storage medium being accessible.

5. The apparatus of claim 3, wherein, when the first application becomes or has become accessible, the manager is configured to manage the first application in place of the dummy application, and the graphic processor is configured to change the first graphic for the dummy application to a third graphic for displaying the first application corresponding to the dummy application.

6. The apparatus of claim 4, further comprising:
a monitor configured to watch the state of connection with the external storage medium,
wherein, when the monitor detects or has detected the connection with the external storage medium and the first application becomes or has become accessible, the manager is configured to manage the first application in place of the dummy application, and the graphic processor is configured to change the first graphic for the dummy application to a third graphic for displaying the first application corresponding to the dummy application.

7. The apparatus of claim 5, wherein, when the first application becomes or has become inaccessible, the manager is configured to manage the dummy application in place of the first application, and the graphic processor is configured to change the third graphic to the first graphic.

8. The apparatus of claim 3, wherein the controller is configured to execute an error process based on the dummy application according to a selection of the first graphic.

9. The apparatus of claim 5, wherein the controller is configured to execute an operation based on the first application according to a selection of the third graphic.

10. An application operation control method comprising:
creating a manager configured to manage an application using XML and script;
creating a dummy application with reference to the manager, the dummy application corresponding to a first application being temporarily inaccessible and being stored in an external storage medium; and
controlling an operation based on the dummy application and a second accessible application managed by the manager.

11. A broadcast receiving apparatus comprising:
a broadcasting receiver configured to receive a broadcast signal;
an application operation controller configured to control an operation of an application; and
an output module configured to output broadcast content corresponding to the broadcast signal and to output application content corresponding to the application, the application operation controller comprising:
a manager configured to manage the application using XML and script,
a creator configured to create a dummy application with reference to the manager, the dummy application corresponding to a first application being temporarily inaccessible and being stored in an external storage medium, and
a controller configured to control an operation based on the dummy application and a second accessible application managed by the manager.
